(19) United States
(12) Patent Application Publication
(10) Pub. No.: US 2016/0325498 A1
(43) Pub. Date: Nov. 10, 2016

(54) 3D Printer Based on a Staggered Nozzle Array

(71) Applicant: Daniel Gelbart, Vancouver (CA)

(72) Inventor: Daniel Gelbart, Vancouver (CA)

(21) Appl. No.: 14/803,088

(22) Filed: Jul. 19, 2015

Related U.S. Application Data
(60) Provisional application No. 62/156,332, filed on May 4, 2015.

(51) Int. Cl. B29C 67/00; B22D 23/00

(52) U.S. Cl. CPC B29C 67/0085; B29C 67/0059; B22D 23/003; B33Y 30/00

(57) ABSTRACT

A 3D printer is based on a two dimensional staggered nozzle array, depositing each layer in a raster scan mode. Each nozzle contains an individually controlled mechanical high speed valve, and multiple nozzles are fed from a constant pressure reservoir, typically containing molten polymer.

### BACKGROUND OF THE INVENTION

The invention relates to the field of 3D printing, also known as “additive manufacturing” or “rapid prototyping”. In 3D printing, a 3D object is created by building it layer by layer. The name “3D printer” in this disclosure should be widely interpreted as any system that generates a 3D object from computer data. The process of forming a single layer in a 3D printer can be classified as vector based or raster based. A vector based printer typically has one nozzle (or one laser) tracing out the object features in each layer. The nozzle (or laser) can move in any direction, typically following the contours of the object. A well known example of vector based printers is the common Fused Deposition Modelling (FDM) printer which operates by moving around a heated nozzle and depositing molten polymer, similar to a hot-melt glue gun. The advantage of FDM printers is that they can use a wide range of low cost structurally strong materials. The main disadvantage is low speed. In a raster based printer the layer is made by an array of nozzles, all moving in the same direction and same distance relative to the layer being built and depositing a set of parallel lines whenever needed. The raster based 3D printers use an ink jet array to deposit photopolymer, which is immediately cured by UV light. Another form of raster based printer uses an ink-jet array to deposit a binder liquid onto a powder bed. The main advantage of raster based printers is large parallelism, as thousands of nozzles can be combined to form a layer in a single path. Unfortunately the only method available today to build a large nozzle array for raster based scanning is based on ink jet technology. Ink jet arrays are not suitable for FDM technology as they can not withstand the high temperatures of molten polymers (200 to 300 degrees C.) and can not handle the very high viscosity of most molten plastics. In order to get a reasonable flow from a viscous molten plastic going through a tiny nozzle, very high pressures are required, typically hundreds of atmospheres. The main reason ink jet arrays can not handle high temperatures and high pressures is that the actuator, typically a piezoelectric element, has to be located in close proximity to the nozzle. Most piezoelectric material can not operate at molten polymer temperatures. Another problem is that ink-jet heads can not handle polymers filled with reinforcements, such as carbon-fiber filled polymers. Such additives immediately plug up the ink jet array unless they are reduced to a sub-micron size, losing most of their benefit. In general the photopolymers used with the ink jet arrays have lower strength, lower temperature range, much higher cost and less selection than polymers used by FDM machines. It is clearly desirable to have an FDM based system with a high degree of parallelism in order to achieve high deposition speeds while retaining the benefits of an FDM system. The term FDM is generally used for a process using a nozzle to deposit a molten plastic filament, the deposition is controlled by advancing the filament into a melt chamber. For lack of a more generic term, in this disclosure the term FDM will be used in a broader sense, to cover any process where a nozzle is fed by a pressurized reservoir and the deposition can be controlled by starting and stopping the pressure. In today's FDM machines the deposition of molten polymer is started and stopped by controlling the motion of the polymer filament fed to the melt chamber. When deposition needs to be stopped the filament is no longer fed, thus the pressure inside the nozzle drops to atmospheric pressure and no valve is needed. The disadvantage of this approach is that a separate feeder is needed for each nozzle. In an ink jet system, the nozzle is open at all times (i.e. there is no valve) and the material is being ejected from the nozzle by a pressure pulse. Some ink jet system, not used in 3D printing, operate differently but non of them have a mechanical valve inside each nozzle. In the current invention each nozzle is closed all the time by a mechanical valve, which opens only when material needs to be deposited. Since the valve is mechanical, e.g. needle valve, it can handle extreme pressures and handle high viscosity materials as well as heavily filled materials, including ceramic pastes, metal particle pastes and even molten metals. In the traditional FDM process the deposited material solidifies by cooling or drying. In this disclosure the term FDM also include materials that solidify by other means such as chemical reaction, heating, actinic radiation such as UV light or any other process that converts the material from a liquid or a paste to a solid. Because of the extreme pressures used in this inventions, even materials classified as gels or solids can be extruded. A prior art FDM printer disclosed in US2014/0242208 has two nozzles, of different sizes, but these nozzles are used one at a time. A cam operated valve mechanism selects which nozzle will be used. Only one nozzle can be used at a time as this is still a vector based machine, If several nozzles will be moving in random directions they could collide. The cam-activated valve in US2014/0242208 does not control the deposition, which is still controlled by starting and stopping the filament feed. Another system is to supply a nozzle with several feeder (extruder) mechanisms to eliminate the valve, but again only one nozzle can be used at a time. US2015/0093465 has multiple feeders feeding one nozzle in order to mix materials.
The general theory of 3D printing and in particular the process of converting a solid object model into a layered model is well known and will not be included in this disclosure. It is also well known how to control an array of nozzles using a computer, as it is used in all ink-jet based machines.

In summary, the main differences between the current invention and prior art FDM systems are:
1. The use of an array of nozzles, each one with its own deposition control, but all moving together relative to the deposited layer in a raster mode, depositing a raster of parallel lines.
2. In the preferred embodiment the deposition is controlled by a valve inside nozzle, and not by filament motion. Pressure before valve is constant regardless of the state of the valve.

The main differences between the current invention and ink jet arrays based printers:
1. Each nozzle in the array has its own mechanical valve built into the nozzle.
2. The actuator for the valve is located outside the nozzle array to allow nozzle to be operated at high temperatures.
3. Nozzles are fed by very high and constant pressure, allowing the deposition of high viscosity materials at much higher rates than ink-jets.

The invention combines the best features of traditional FDM machines with the high number of nozzles possible in ink-jet machines to create a machine hundreds of times faster than prior art machines. The reason the invention is much faster than an ink-jet machine with the same number of nozzles is the much higher deposition rate of each nozzle, driven by the ability to operate at much higher pressures.

### SUMMARY OF THE INVENTION

A 3D printer is based on a two dimensional staggered nozzle array, depositing each layer in a raster scan mode. Each nozzle contains an individually controlled mechanical high speed valve, and multiple nozzles are fed from a constant pressure reservoir, typically containing molten polymer.

### BRIEF DESCRIPTION OF THE DRAWINGS

FIG. 1 is a general view of the invention, not including the enclosure and computer controls.

FIG. 2 is a plan view of the nozzle array, illustrating how the effective nozzle pitch is reduced by staggering a two dimensional array of nozzles.

FIG. 3 is a cross-section of the nozzle array and the actuator array.

FIG. 4 is a cross section of a single nozzle, showing the valve details.

FIG. 5 is a side view of the nozzle array, showing the principle of staggering the actuators to achieve a reduced nozzle pitch.

### DETAILED DISCLOSURE

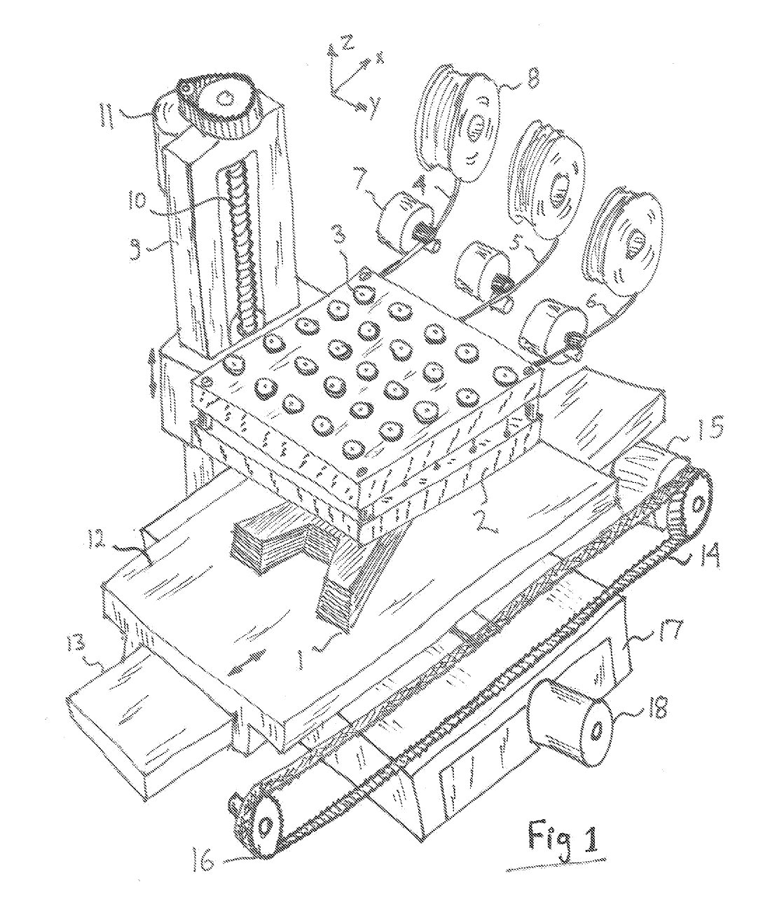

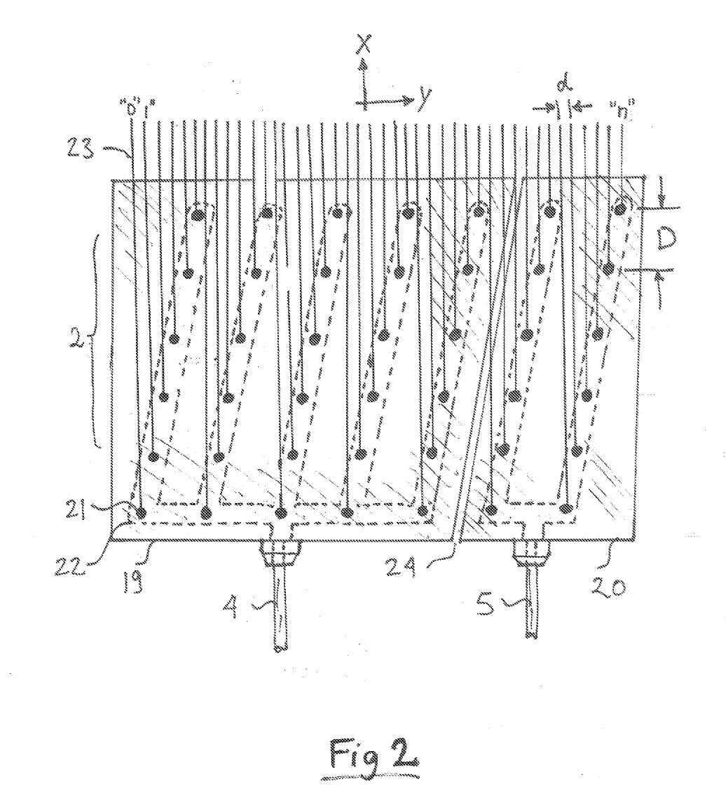

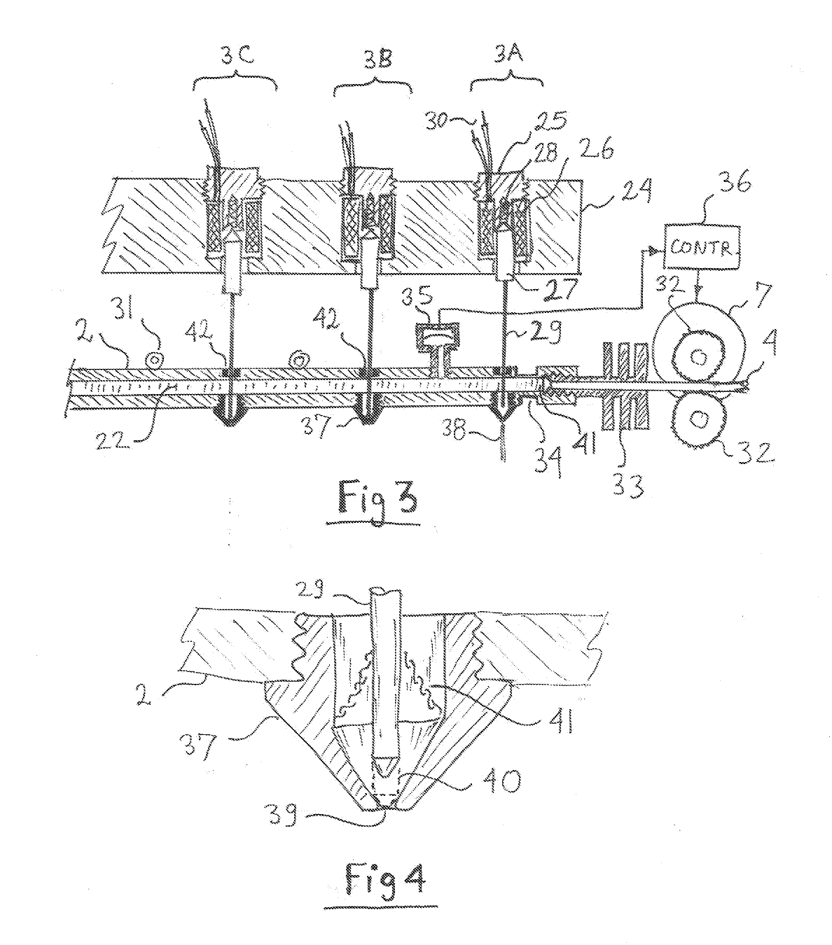

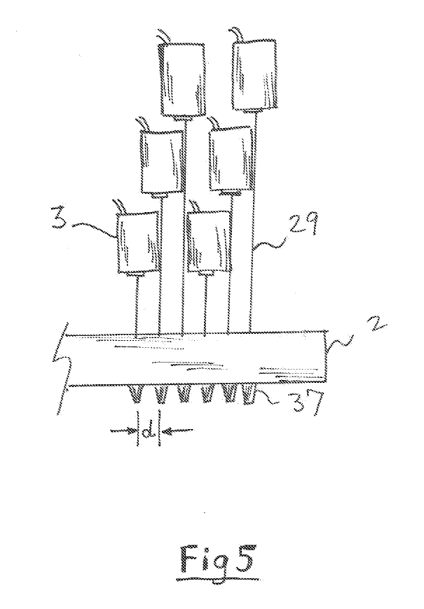

FIG. 1 shows a 3D printer based on a staggered nozzle array. An object 1 is being built up layer by layer by multiple nozzles forming nozzle array 2. Typically nozzle array 2 is heated and the nozzles are depositing molten polymers, such as ABS or PLA. Each nozzle contains a valve actuated by actuator 3. Since nozzles are mounted together, all deposited lines forming a layer will be deposited as parallel lines, raster-scan style. The relative motion between nozzle array 2 and object 1, being formed on bed 12, can be done by moving bed 12 or the nozzle plate 2. In the preferred embodiment object 1 is moving. In the preferred embodiment the number of nozzles is sufficiently high, typically 100 to 1000, to allow the deposition of a complete layer in one pass of bed 12 under nozzle array 2. Bed 12 is mounted on a linear slide 13 and driven by motor 15 via timing belt 14. In the preferred embodiment all motors in FIG. 1 are stepper motors, therefore their position is is known without using sensors. Idler pulley 16 keeps belt tensioned. If the complete layer can not be created in one pass, cross slide 17 driven by motor 18 can be used to move bed 12 relative to nozzle array 2. The fast scan direction is referred to as the X axis, the cross slide is the Y axis and the elevation is the Z axis. The Y axis scan can be done in two modes:
A. Writing a group of contiguous parallel lines and stepping over to write another group.
B. Writing a group of spaced parallel lines and moving over to fill in the spaces with another set of lines. This is usually referred to as “interleaving” and can be done continuously if The right ratio of pitch to number of lines is chosen.
After a layer is completed the distance between the nozzle array 2 and object 1 is increased by one layer thickness and the process is repeated. The elevation is controlled by the Z axis linear guide 9, using lead screw 10 driven by motor 11. Since Z axis movements are small a lead screw can be used. Nozzle array 2 can be a single array or segmented into several arrays, each one fed by a different material. By the way of example, filament 4 coming from spool 8 can be the main building material, such as ABS. Another part of the array can be fed by filament 5, which could be a different polymer such as PLA, and a third filament 6 can be a water-soluble support material. The filaments, typically 3 mm in diameter, are fed by conventional serrated wheel feeder 7, similar to current FDM machines. For very high volumes feeder 7 can be replaced by a screw extruder. The advantage of a screw extruder is that it can use lower cost pellets of polymer instead of a filament on a spool. A screw extruder is very different from the filament pushing mechanism in 3D printers that is known as “extruder”. Screw extruders are used in injection molding machines.
The layout of the nozzle array is shown in FIG. 2. Array 2 contains multiple nozzle locations 21 arranged in a staggered two dimensional array, in order to reduce the apparent spacing of lines 23 in the Y direction. If the actual nozzle spacing is D and there are n nozzles in each column the apparent line spacing in the Y direction will be d=D/n. By the way of example, a 32×32 nozzle array (1024 nozzles) on a 12.8 mm pitch will have an apparent nozzle spacing of 12.8 mm/32=0.4 mm. Such an array can be used to write a layer of 1024×0.4 mm=409.6 mm wide in one pass, or at an increased resolution of 0.2 mm in two passes. In this high resolution mode the 0.2 mm lines are still written on 0.4 mm pitch, the gaps filled in by another set of 0.2 mm lines on the return pass. The writing can be bi-directional, one pass is written during the forward motion and one pass at the return motion. The reason it is possible to generate a different deposited line width from the same nozzle size is that the deposited line diameter is a function of two parameters: flow rate and relative motion speed between nozzle and object. A slow motion and a high flow rate will create a thick line, as a lot of material is deposited per unit length. A low flow and high motion speed will generate a thin deposited line, as needed for high resolution. The flow rate is a function of nozzle size, pressure and viscosity (temperature dependent). The pressure can be change instantly, as explained later. The nozzle array in FIG. 2 can be segmented into several arrays such as 19 and 20. It is desired to leave a small gap 24 between the segments as each segment may contain a different material and may require a different temperature. It is also desired to keep the overall pitch of the array constant, including gap 24, to allow all segments to be fed with the same material for maximum deposition speed for objects only requiring a single material. Since the starting point of each raster line is different, because of the staggered array layout, the control software needs to take this shift into account and shift the data by the same amount. This is already done today in all ink jet arrays. While the preferred embodiment is a staggered array of nozzles as shown in FIG. 2, the raster scan pattern can be generated by any arrangement of nozzles. For example, a linear array in the Y direction can be used to deposit widely spaced lines, with subsequent scans filling in the missing lines by moving the object relative to the array in the Y direction after each raster scan. Such a mode is known as interleaving.
Nozzle array 2 also contains internal channels 22 (shown in dotted lines) to connect all nozzles in a given segment to one supply manifold. Each manifold is fed by a separate filament, 4 and 5.
Software can also be used to make the array more fault tolerant. If one or more nozzles are plugged the software can decide which is the maximum contiguous usable array size and keep printing at a reduced speed. Array can also include isolation valves (manual or automatic) to segment it even further in case the fault is a nozzle that would not close. By the way of example, if segment 19 contains 512 nozzles and nozzles 50 and 450 are plugged, the largest contiguous block is from nozzle 51 to nozzle 449. The software can re-format the data for this block size and printing can continue at about 80% of original speed.
Sometimes novel properties can be achieved by co-deposition of materials. For example, cross linking can be achieved by interleaved deposition of two reactive materials, as an epoxy resin and activator. The segmented array allows co-deposition. Another co-deposition application is high temperature ceramic shell molds, where the hardening of the ceramic paste can be accelerate by co-deposition of an activator fluid.
While the preferred embodiment uses a nozzle array having a valve inside each nozzle to control the deposition based on the layer data, it is also possible to build a nozzle array generating a raster of parallel lines by having a separate filament feed for each nozzle instead of a valve. This is equivalent to combining many prior art FDM extruders into an array and using them to create a raster scan instead of a vector scan. Obviously this approach is practical only for a relatively small number of nozzles, typically less than 100.
The details of the nozzle array construction are shown in FIGS. 3 and 4. The preferred embodiment uses electromagnetic actuators, but the invention covers any type of actuator: piezoelectric, hydraulic, magnetostrictive etc. The main advantage of hydraulic actuators such as hydraulic valves controlling miniature pistons is that the pitch of the nozzle array can be made much smaller than the pitch of the hydraulic valves, as they are coupled by thin tubing.
For electromagnetic actuators a steel plate 24 contains coils 26 held by steel plugs 25. Plugs 25 can be threaded, as a thread also allows adjustment of the position of needle 29, in order to balance the flow from all nozzles. Needles 29 are attached to plungers 27. A spring 28 provides the return force. By the way of example, needle 29 is 0.4 mm diameter, nozzle orifice is 0.3 mm and return force provided by spring 28 is 500 grams. Coil leads 30 are wired to a driver circuit controlled by the system computer, based on the raster data. The coil details are not important, as long as the driver is matched to the coil. To reduce coil heating the driver can reduce the drive current after several milliseconds or after sensing that the valve opened. When the solenoid plunger 27 is pulled in, the inductance of the coil increases significantly. This change in inductance can be used to sense plunger position, for power reduction as well as for detecting a valve that did not close. An alternate method for sensing valve operation is a camera looking at the bed 12 with all nozzles closed and all nozzles momentarily opened. Typical coil dimensions are 11 mm diameter×18 mm long. Typical plunger travel is under 1 mm. Actuation speed for these parameters is about 1 mS. Raster scanning speed is typically 200-1000 mm/sec. Needle 29 needs to be sufficiently long to keep the hot nozzle array 2 at a distance, typically 30-50 mm, from plate 24. Thermal insulation can be added between plate 24 and nozzle plate 2.
Nozzle array 2 is typically kept at 200-300 deg C., but can use much higher temperatures for special materials. Nozzle array 2 is made from a heat conductive material such as brass, aluminum or copper. It is kept at a constant temperature via heaters 31. It may be desirable to divide the heated zone into two areas, one for rapid melting the fed filament and another for keeping the nozzle area at constant temperature. The area in which the rapidly fed filament is melting requires a much larger heat input than the nozzle area. For some polymers it may be desired to provide recirculation of the molten polymer, preferable through a filter to trap impurities. Recirculation can be active, by using an impeller inside the molten polymer driven by a motor located outside the nozzle late. Recirculation can also be passive, by generating small pressure gradients inside manifold 22 using ventury sections. Needles 29 pass through seals 42 to open and close the orifice of nozzles 37. Seals 42 can be made from a high temperature polymer such as Vespel, ceramic material or of metal. Needles 29 are typically made from hardened stainless steel with a diameter of under 1 mm. Seals 42 can be made longer to provide better needle guidance. FIG. 3 shows actuator 3A as energized (nozzle open, depositing material 38) and actuators 3B and 3C as turned off. FIG. 4 shows an enlarged cross section of nozzle 37 with the closed position shown as dotted line 40. When actuator is off needle 29 plugs orifice 39. An optional metal screen filter 41 traps impurities.
Since the cross section area of needle 29 is small, typically 0.12-0.2 sq.mm, even a spring force of 500 gm (about 5N) can seal against a pressure of 500 g/0.12 sq mm˜400 atm.
The pressure regulation system comprises of filament feeder serated wheels 32, motor 7, controller 36 and pressure sensor 35. When pressure drop is sensed by sensor 35, controller 36 commands motor 7 to feed more filament 4 into manifold 22. The filament itself acts as a piston, similar to prior art FDM machines. Unlike prior art FDM machines, pressure has to be retained even when no material is deposited, so a better sealing mechanism 41 is needed. To help with sealing, a temperature gradient is generated by thermal break 34. This generates a much higher viscosity polymer in area of seal 41. Several types of seals can be used: an elastomeric seal made of silicone rubber, a rigid seal made of metal or high temperature polymer such as Vespel or Teflon, or a self sealing tapered seal. The self sealing tapered seal relies on the fact that the metal parts, typically copper, to the right of the seal are at room temperature thanks to heat sink 33. When the barely molten polymer enters the taper seal 41 is solidifies and forms a plug. Pushing filament 4 inwards forces the plug into the higher temperature zone and re-melts it. When feed stops material solidifies again.
It is desired to reduce the size of nozzle array 2 in order to conserve heating power and avoid needless movement in the X direction. Since the nozzles are small, the pitch of the array is limited by the actuator size. Arranging the actuators at several levels, as shown in FIG. 5, allows to reduce the pitch of the nozzle array. A similar reduction can be achieved be bending the needles 29 into an arc and placing the actuators 3 on a spherical plate.
While the primary use of the invention is to build objects from molten polymers, similar to traditional FDM, the invention can be used for processes which do not rely on cooling to solidify the deposited lines. The printer can deposit a room temperature polymer cured by radiation, such as a UV light source. A 100 mW 400 nm laser diode can be focused at each nozzle or each line. This allows structures to be built with less support. The nozzle array can be used at room temperature or even cooled to deposit reactive materials. For example, a slow reacting epoxy resin can be mixed and deposited cold into a heated build chamber, reacting and cross linking in the build chamber. The epoxy can be made thixotropic (i.e. non flowing paste) by using a suitable filler such as glass or polymer micro-balloons. Depositing thixotropic materials allows building objects with minimal support structures. The machine can also produce metal parts either by depositing a low melting point metal, such as a zinc alloy, or by producing a ceramic shell for shell casting from a ceramic paste, such as alumina paste. The volume where the object is being built up is known as the build chamber. Special conditions in the build chamber can be beneficial for these processes. Special conditions can include a controlled temperature, radiation (UV or other), controlled humidity, special gasses etc. For example, some ceramic pastes cure faster in a CO2 rich atmosphere as they become rigid by forming carbonates. Another way of producing metal parts with the invention is to deposit metal pastes and sinter the pastes into a solid metal object later. Because the invention operates at very high pressures, it can deposit pastes with a high concentration of metal. The pastes can be as simple as a mixture of base metal, binder metal, water and flux. Such a metal object can be dried and heated to become a solid metal part.

1. A 3D printer for layer-by-layer deposition of a 3D object, each layer is deposited by a plurality of raster scanning nozzles, each nozzle having a valve controlled by the layer data.

2. A 3D printer for layer-by-layer deposition of a 3D object, each layer is deposited by a staggered array of nozzles and each nozzle having a valve controlled by the layer data.

3. A 3D printer for layer-by-layer deposition of a 3D object, each layer is deposited by an array of heated nozzles depositing molten polymer as a raster of parallel lines and each nozzle being fed from a separate polymer feeder.

4. A 3D printer as in claim 1 wherein said valve is an electromagnetically controlled needle valve.

5. A 3D printer as in claim 2 wherein said valve is an electromagnetically controlled needle valve.

6. A 3D printer as in claim 1 wherein nozzles are fed molten polymer by a screw extruder.

7. A 3D printer as in claim 1 wherein the deposited material is supplied to the nozzles from a constant pressure manifold.

8. A 3D printer as in claim 1 wherein said nozzles and valves are mounted on a common nozzle plate, each valve controlled by an actuator not mounted on said plate.

9. A 3D printer as in claim 2 wherein said nozzles and valves are mounted on a common nozzle plate, each valve controlled by an actuator not mounted on said plate.

10. A 3D printer as in claim 1 wherein said nozzles deposit molten polymer.

11. A 3D printer as in claim 1 wherein said nozzles deposit a ceramic paste.

12. A 3D printer as in claim 1 wherein said nozzles deposit a paste containing metal.

13. A 3D printer as in claim 1 wherein said nozzles deposit a radiation curable polymer.

14. A 3D printer as in claim 1 wherein said nozzles deposit a reactive polymer, reaction taking place after deposition of polymer.

15. A 3D printer as in claim 1 wherein said nozzles deposit a thixotropic material.

16. A 3D printer as in claim 1 wherein said nozzles deposit molten metal.

17. A 3D printer as in claim 1 wherein said nozzles deposit a material into a build chamber having controlled conditions.

18. A 3D printer as in claim 1 wherein said nozzles form a linear array.

19. A 3D printer as in claim 1 wherein said layer deposition is done by interleaving multiple raster scans.

20. A 3D printer as in claim 1 comprising a polymer filament fed into a manifold of molten polymer, wherein sealing around the polymer filament is based on solidification of the molten polymer.
